(19) United States
(12) Patent Application Publication
(10) Pub. No.: US 2018/0051785 A1
(43) Pub. Date: Feb. 22, 2018

(54) TORQUE TRANSMISSION DEVICE

(71) Applicant: Schaeffler Technologies AG & Co. KG, Herzogenaurach (DE)

(72) Inventor: Christian Gradolph, Rohrbach (DE)

(73) Assignee: Schaeffler Technologies AG & Co. KG, Herzogenaurach (DE)

(21) Appl. No.: 15/558,468

(22) PCT Filed: Feb. 25, 2016
(86) PCT No.: PCT/DE2016/200108

§ 371 Date: Sep. 14, 2017

(30) Foreign Application Priority Data
Mar. 25, 2015 (DE) 10 2015 205 397.0

(51) Int. Cl. F16H 45/02

(52) U.S. Cl. CPC F16H 45/02; F16H 2045/0263; F16H 2045/0205; F16H 2045/0294

(57) ABSTRACT

A torque transmission device active between a drive side and an output side is disclosed. The torque transmission device comprises a torque converter that has a housing in which a pump, a turbine, and a lock-up clutch for transmission of a torque are arranged between the drive side and the output side. The lock-up clutch has a clutch input coupled to the housing, a clutch output which is rotatable with respect thereto, and an actuating element for actuating the lock-up clutch. The turbine is axially displaceable together with the actuating element, and the turbine is rotatable with respect to the clutch output.

### CROSS-REFERENCE TO RELATED APPLICATIONS

This application is the U.S. National Phase of PCT Appln. No. PCT/DE2016/200108 filed Feb. 25, 2016, which claims priority to German Application No. DE 10 2015 205 397.0 filed Mar. 25, 2015, the entire disclosures of which are incorporated by reference herein.

### TECHNICAL FIELD

The present disclosure relates to a torque transmission device.

### BACKGROUND

DE102013202661 discloses a torque transmission device arranged in a drivetrain of a motor vehicle, which torque transmission device is arranged actively between a drive side and an output side and comprises a torque converter which has a housing in which a pump, a turbine and a lock-up clutch for transmission of a torque are arranged between the drive side and the output side, wherein the lock-up clutch has an axially displaceable actuating element formed as a turbine for actuating the lock-up clutch.

### SUMMARY

The object of the disclosure lies in improving the reliability of a torque transmission device, reducing production costs, reducing installation space requirements, reducing torsional vibrations in particular when using a torsional vibration damper and/or a vibration absorber device and/or improving performance, in particular of the lock-up clutch.

According to the disclosure, this object is achieved by a torque transmission device with the features as claimed in the claims.

There is correspondingly proposed a torque transmission device active between a drive side and an output side and comprising a torque converter which has a housing in which a pump, a turbine and a lock-up clutch for transmission of a torque are arranged between the drive side and the output side, wherein the lock-up clutch has a clutch input coupled to the housing, a clutch output which is rotatable with respect thereto and an actuating element for actuating the lock-up clutch, wherein the turbine is axially displaceable together with the actuating element, wherein the turbine is rotatable with respect to the clutch output. As a result, in particular torsional vibrations can be reduced to a greater extent.

One preferred embodiment of the disclosure is characterized in that the actuating element is fastened directly on the turbine.

Another embodiment of the disclosure is characterized in that the actuating element and the turbine are formed in one piece.

A further embodiment of the disclosure is characterized in that the actuating element for actuating the lock-up clutch acts in the direction of the housing.

One advantageous embodiment of the disclosure is characterized in that the turbine is rotatable to a limited extent with respect to the clutch output.

One preferred embodiment of the disclosure is characterized in that the torque transmission device comprising a torsional vibration damper has energy storage elements and/or a vibration absorber device, in particular a centrifugal pendulum-type device.

The torsional vibration damper comprises at least one damper input part and one damper output part which is rotatable to a limited extent with respect thereto by the action of energy storage elements. A further second damper stage connected in parallel or in series thereto, also having a second damper input part and a second damper output part which is rotatable to a limited extent with respect thereto by the action of second energy storage elements, can also be provided. In the case of connection in series, the second damper input part acts as a damper intermediate part. The turbine can be fitted on a damper component which is rotatable via the action of the energy storage elements, such as damper input part or damper intermediate part or damper output part.

Independently of this, it also lies in the framework of the disclosure to fit the turbine on a different damper component of the torsional vibration damper, such as, for example, the damper intermediate part.

Stop means for limiting a maximum rotatability between turbine and clutch output can generally be provided in the region of the connecting point between turbine and clutch output and/or disk element.

A further embodiment of the disclosure is characterized in that the turbine is rotatable with respect to the clutch output counter to the action of the energy storage elements.

One preferred embodiment of the disclosure is characterized in that the turbine is rotatable with respect to the clutch output via the action of a bearing, in particular a plain bearing and/or an anti-friction bearing.

The friction which occurs between turbine and clutch output and/or disk element as a result of the axial force present for the actuation of the lock-up clutch as a result of the turbine and the relative rotatability of both components can be used in a targeted manner to bring about energy dissipation and/or hysteresis in the action of the torsional vibration damper. When using a plain bearing between turbine and clutch output and/or disk element, in particular the disk element and/or the turbine are/is formed as a washer disk.

One preferred embodiment of the disclosure is characterized in that the turbine can exert an axial force on the lock-up clutch, in particular on the clutch output and/or a disk element, via the actuating element for actuation of the lock-up clutch.

Another embodiment of the disclosure is characterized in that the clutch output and/or the housing receive(s) at least one friction lining.

A sealing element can generally be actively arranged between the clutch output and/or the disk element. In particular, the sealing element can be formed by a sealing ring and/or a spring element, especially a plate spring. The sealing element is arranged in particular in the region of the upper half of the radial extent of the turbine, particularly preferably at the radial height of the friction lining and/or radially outside the friction lining.

The torque converter can generally also be connected to a torsional vibration damping device and/or vibration absorber device arranged outside the housing.

Further advantages and advantageous embodiments of the disclosure will become apparent from the description and the illustrations.

### BRIEF DESCRIPTION OF THE DRAWINGS

The disclosure is described in detail below with reference to the illustrations.

In detail:

FIG. 1: shows a half-section of a cross-section through a torque transmission device in one embodiment of the disclosure.

FIG. 2a: shows a cut-out of the cross-section shown in FIG. 1 through the torque transmission device.

FIG. 2b: shows a cut-out of a cross-section through a torque transmission device in a further embodiment of the disclosure.

FIG. 3: shows a cut-out of a cross-section through a torque transmission device in a further embodiment of the disclosure.

FIG. 4: shows a top view of a part of a torque transmission device in a further embodiment of the disclosure.

FIG. 5: shows a cut-out of a cross-section through a torque transmission device in a further embodiment of the disclosure.

### DETAILED DESCRIPTION

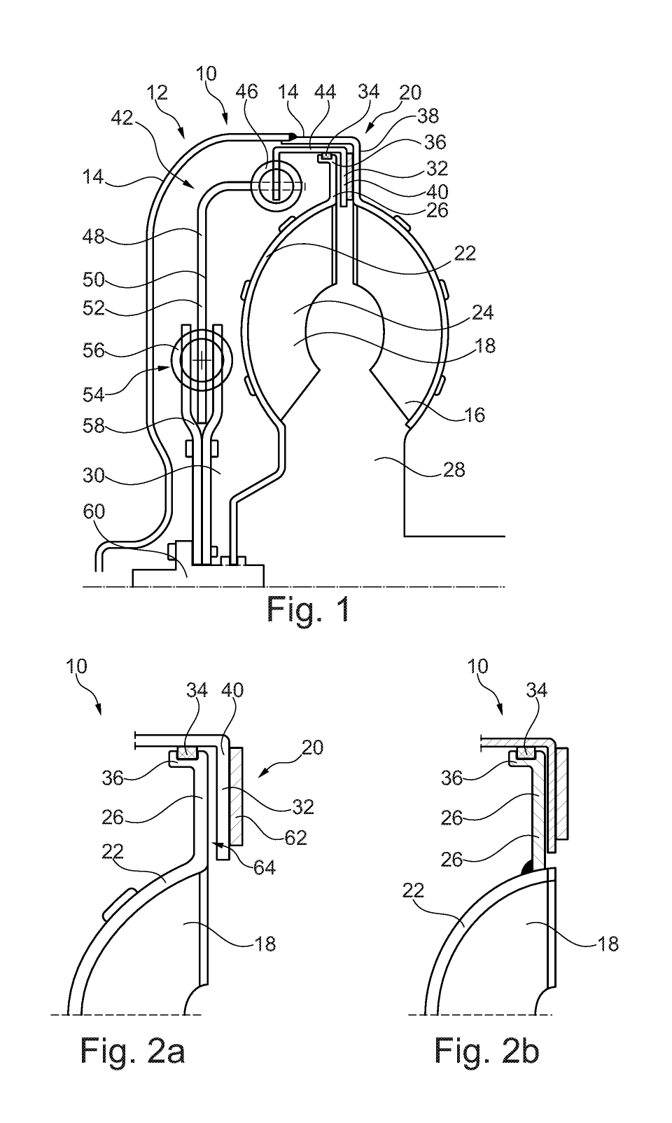

FIG. 1 shows a half-section of a cross-section through a torque transmission device 10 in one embodiment of the disclosure. This comprises a torque converter 12 which is actively introduced between a drive side and an output side and which has a housing 14, in which a pump 16, a turbine 18 and a lock-up clutch 20 for transmission of a torque are arranged between the drive side and output side. Turbine 18 comprises a turbine wheel lining 22 and turbine vanes 24 which are fastened thereon.

Lock-up clutch 20 has an axially displaceable actuating element 26 for actuating lock-up clutch 20 which is formed in particular in one piece with turbine 18. To this end, turbine 18 is also axially displaceable and is moved by a pressure difference between torus chamber 28 and outer chamber 30 in order for an axial force to act on lock-up clutch 20.

The force acts in particular between turbine 18 and clutch output 32 which is formed especially here as disk element 40. Clutch output 32 is rotatable with respect to turbine 18. A sealing element 34 which is placed in a seal carrier 36 can be provided as a seal between turbine 18 and clutch output 32. Seal carrier 36 can be formed in particular in one piece with actuating element 26. Seal element 34 is formed in particular as a sealing ring.

Housing 14 forms in particular clutch input 38 of lock-up clutch 20 and disk element 40 forms in particular clutch output 32 of lock-up clutch 20.

Clutch output 32 is generally arranged on a damper input part 44 of a torsional vibration damper 42 or formed in one piece therewith.

Damper input part 44 acts in this case via energy storage elements 46 on a damper output part 48 which is rotatable to a limited extent with respect to damper input part 44 and which is formed here in particular as damper intermediate part 50 which in turn forms a second damper input part 52 of a downstream damper stage 54 and which acts via further second energy storage elements 56 on a second damper output part 58 which is rotatable to a limited extent with respect to second damper input part 52.

Second damper output part 58 is connected to a drive hub 60 in particular in a rotationally conjoint manner. In particular, turbine 18 is also connected to drive hub 60 or second damper output part 58 in a rotationally conjoint, but axially displaceable, manner. As a result, the vibration mass on the output side of torsional vibration damper 42 can be increased by the mass of turbines 18.

A cut-out of a cross-section through a torque transmission device 10 in one embodiment of the disclosure is represented in FIG. 2a. Disk element 40 is formed in one piece with turbine 18, in particular turbine lining 22 and is pushed via axially displaceable turbine 18 for closing of lock-up clutch 20 by an axial force in the direction of housing, to which end a friction lining 62, in particular on disk element 40, enables a transmission of torque between housing as clutch input and disk element 40 as clutch output 32 in the case of closed or partially closed lock-up clutch 20.

Turbine 18 is rotatable to a limited extent with respect to disk element 40 as clutch output 32. A plain bearing 64 is provided in particular here. To this end, in particular friction-reducing materials and/or components can be used to reduce the friction in the case of relative rotation between clutch output 32 and turbine 18. The friction can also be used in a targeted manner to bring about hysteresis in the case of the torsional vibration damper.

FIG. 2b shows a cut-out of a cross-section through a torque transmission device 10 in a further embodiment of the disclosure. In this case, actuating element 26 is connected fixedly, in particular welded, to turbine 18, especially to turbine wheel lining 22.

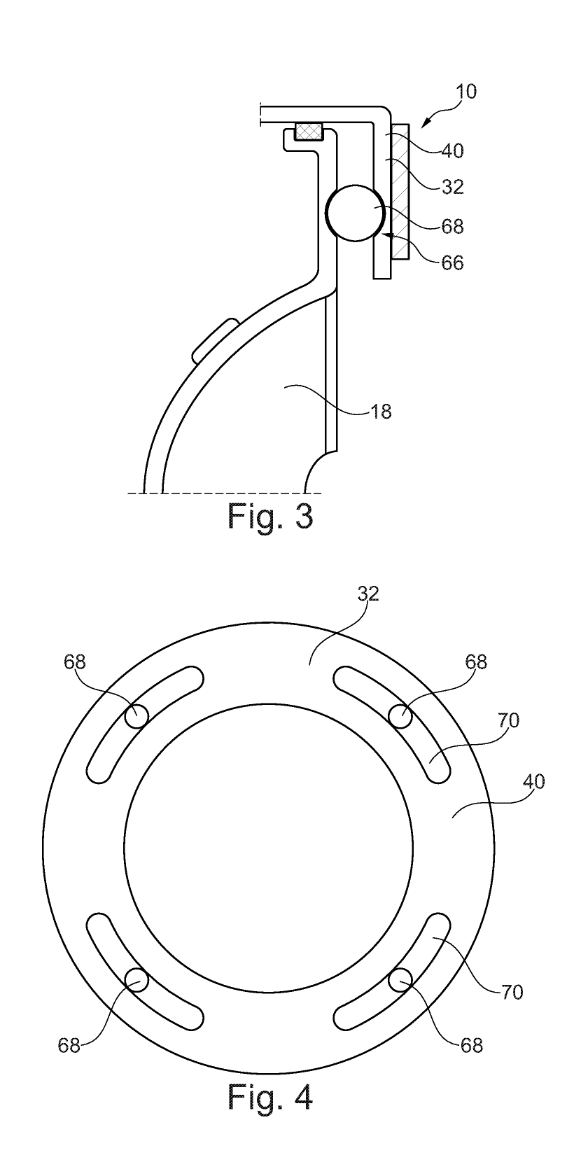

A cut-out of a cross-section through a torque transmission device 10 in a further embodiment of the disclosure is represented in FIG. 3. Turbine 18 is rotatable with respect to clutch output 32, here disk element 40, via the action of a bearing 66, in particular of an anti-friction bearing. The anti-friction bearing comprises in particular, as is apparent in FIG. 4, a total of four roller elements 68, here in the form of balls which enable a transmission of an axial force between turbine 18 and disk element 40 but simultaneously also a limited rotatability between turbine 18 and disk element 40.

Roller elements 68 can roll in paths 70 extending to a limited extent on the circumferential side. The limited extension on the circumferential side can also have the effect of a stop, i.e. limitation of a maximum rotatability between turbine 18 and disk element 40. As a result, particularly when using a torsional vibration damper, a stop can be brought about between damper components coupled by energy storage elements, such as damper input part and damper output part.

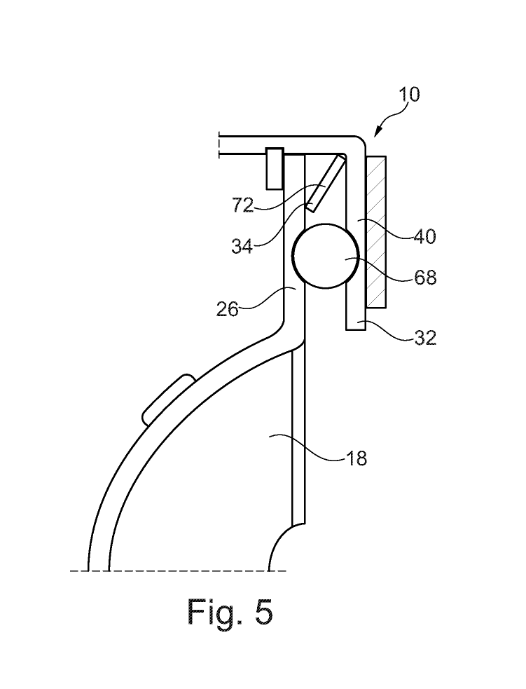

FIG. 5 shows a cut-out of a cross-section through a torque transmission device 10 in a further embodiment of the disclosure. In this case, a sealing element 34, formed here in particular as plate spring 72, is provided for sealing between turbine 18 and clutch output 32.

### LIST OF REFERENCE NUMBERS

10 Torque transmission device
12 Torque transmitter
14 Housing
16 Pump
18 Turbine
20 Lock-up clutch
22 Turbine wheel lining
24 Turbine vanes
26 Actuating element
28 Torus chamber
30 Outer chamber
32 Clutch output
34 Sealing element
36 Seal carrier
38 Clutch input
40 Disk element
42 Torsional vibration damper
44 Damper input part
46 Energy storage element
48 Damper output part
50 Damper intermediate part
52 Damper input part
54 Damper stage
56 Energy storage element
58 Damper output part
60 Drive hub
62 Friction lining
64 Plain bearing
66 Bearing
68 Roller element
70 Paths
72 Plate spring

1. A torque transmission device active between a drive side and an output side and comprising a torque converter which has a housing in which a pump, a turbine and a lock-up clutch for transmission of a torque are arranged between the drive side and the output side, wherein the lock-up clutch has a clutch input coupled to the housing, a clutch output which is rotatable with respect thereto and an actuating element for actuating the lock-up clutch, wherein the turbine is axially displaceable together with the actuating element, and wherein the turbine is rotatable with respect to the clutch output.

2. The torque transmission device as claimed in claim 1, wherein the actuating element is fastened directly on the turbine.

3. The torque transmission device as claimed in claim 1, wherein the actuating element and the turbine are formed in one piece.

4. The torque transmission device as claimed in claim 1, wherein the actuating element for actuating the lock-up clutch acts in a direction of the housing.

5. The torque transmission device as claimed in claim 1, wherein the turbine is rotatable to a limited extent with respect to the clutch output.

6. The torque transmission device as claimed in claim 1, wherein the torque transmission device has a torsional vibration damper comprising energy storage elements and/or a vibration absorber device.

7. The torque transmission device as claimed in claim 6, wherein the turbine is rotatable with respect to the clutch output counter to an action of the energy storage elements.

8. The torque transmission device as claimed in claim 1, wherein the turbine is rotatable with respect to the clutch output via action of a bearing.

9. The torque transmission device as claimed in claim 1, wherein the turbine is arranged to exert an axial force on the clutch output of the lock-up clutch via the actuating element for actuation of the lock-up clutch.

10. The torque transmission device as claimed in claim 1, wherein the clutch output and/or the housing receive(s) at least one friction lining.

11. The torque transmission device as claimed in claim 6, wherein the vibration absorber device is a centrifugal pendulum.

12. The torque transmission device as claimed in claim 8, wherein the bearing is one of a plain bearing and an anti-friction bearing.

13. A torque converter, comprising:
a housing;
a pump;
a turbine;
a lock-up clutch for transmission of torque, wherein the lock-up clutch includes:
a clutch input coupled to the housing;
a clutch output rotatable with respect to the turbine; and,
an actuating element connected to the turbine and arranged for actuating the lock-up clutch; and,
a torsional vibration damper including:
a first damper stage having a first damper input part and a first damper output part, wherein the clutch output is coupled to the first damper input part; and,
a second damper stage having a second damper input part and a second damper output part, wherein the first damper output part of the first damper stage is connected to the second damper input part of the second damper stage.

14. The torque converter as claimed in claim 13, wherein the first damper output part of the first damper stage and the second damper input part of the second damper stage are formed as one piece.

15. The torque converter as claimed in claim 13, wherein the turbine is further coupled to the first damper input part of the first damper stage.

16. The torque converter as claimed in claim 13, further comprising a sealing element disposed between the actuating element and the clutch output of the lock-up clutch.

17. The torque converter as claimed in claim 16, wherein the sealing element is one of a sealing ring and a spring element.

18. The torque converter as claimed in claim 13, further comprising at least one stop provided at a connecting point between the turbine and the clutch output, the at least one stop being arranged to limit a maximum rotatability between the turbine and the clutch output.
